(19) United States
(12) Patent Application Publication
(10) Pub. No.: US 2008/0213624 A1
(43) Pub. Date: Sep. 4, 2008

(54) ORGANIC ELECTRONIC DEVICE

(75) Inventors: DANIEL DAVID LECLOUX, WILMINGTON, DE (US); Eric Maurice Smith, Hockessin, DE (US); Norman Herron, Newark, DE (US); Charles J. Dubois, Wilmington, DE (US); Weishi Wu, Bear, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, WILMINGTON, DE (US)

(21) Appl. No.: 12/037,495

(22) Filed: Feb. 26, 2008

Related U.S. Application Data
(60) Provisional application No. 60/891,961, filed on Feb. 28, 2007.

(51) Int. Cl. H05B 33/14

(52) U.S. Cl. 428/691; 428/690

(57) ABSTRACT

There is provided an organic electronic device having an anode and a cathode and having organic layers therebetween. The organic layers are, in order: a buffer layer including a conductive polymer and a fluorinated acid polymer; a hole transport layer; a photoactive layer including a dopant material and a host material; and an electron transport layer; wherein at least one of the dopant material and the host material is a fused polycyclic aromatic compound.

### BACKGROUND INFORMATION

1. Field of the Disclosure

This disclosure relates in general to organic electronic devices. In particular, it relates to devices in which at least some organic active layers are formed by solution processing.

2. Description of the Related Art

In organic electronic devices, such as organic light emitting diodes (“OLED”), that make up OLED displays, an organic active layer is sandwiched between two electrical contact layers in an OLED display. In an OLED the organic active layer is a photoactive layer which emits light through the light-transmitting electrical contact layer upon application of a voltage across the electrical contact layers.

It is well known to use organic electroluminescent compounds as the photoactive component in light-emitting diodes. Simple organic molecules, conjugated polymers, and organometallic complexes have been used. Devices that use photoactive materials frequently include one or more charge transport layers, which are positioned between a photoactive (e.g., light-emitting) layer and a contact layer (hole-injecting contact layer). A device can contain two or more contact layers. A hole transport layer can be positioned between the photoactive layer and the hole-injecting contact layer. The hole-injecting contact layer may also be called the anode. An electron transport layer can be positioned between the photoactive layer and the electron-injecting contact layer. The electron-injecting contact layer may also be called the cathode.

There is a continuing need for electronic devices having improved performance.

### SUMMARY

There is provided an organic electronic device comprising an anode and a cathode and having organic layers there between, wherein the organic layers are, in order:

a buffer layer comprising a conductive polymer and a fluorinated acid polymer;

a hole transport layer;

a photoactive layer comprising a dopant material and a host material; and

an electron transport layer

wherein at least one of the dopant material and the host material is a fused polycyclic aromatic compound.

There is also provided an organic electronic device as described above, wherein both the dopant material and the host material are fused polycyclic aromatic compounds.

There is also provided an organic electronic device as described above, wherein the dopant material is a fused polycyclic aromatic compound having a core structure selected from the group consisting of pentalene, indene, naphthalene, azulene, heptalene, biphenylene, as-indacene, s-indacene, acehaphthylene, fluorene, phenalene, phenanthrene, anthracene, fluoroanthene, acephenanthrylene, aceanthrylene, triphenylene, pyrene, chrysene, tetracene, pleiadene, picene, perylene, pentaphene, pentacene, tetraphenylene, hexaphene, hexacene, rubicene, coronene, trinaphthylene, heptaphene, heptacene, pyranthrene, ovalene, truxene, dibenzosuberan, and combinations thereof.

There is also provided an organic electronic device as described above, wherein the host material is a fused polycyclic aromatic compound having a core structure selected from the group consisting of pentalene, indene, naphthalene, azulene, heptalene, biphenylene, as-indacene, s-indacene, acehaphthylene, fluorene, phenalene, phenanthrene, anthracene, fluoroanthene, acephenanthrylene, aceanthrylene, triphenylene, pyrene, chrysene, tetracene, pleiadene, picene, perylene, pentaphene, pentacene, tetraphenylene, hexaphene, hexacene, rubicene, coronene, trinaphthylene, heptaphene, heptacene, pyranthrene, ovalene, truxene, dibenzosuberan, and combinations thereof.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented herein.

FIG. 1 includes as illustration of one example of an organic electronic device.

Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by the Device Structure, the Photoactive Layer, the Hole Transport Layer, the Buffer Layer, Other Device Layers, Device Fabrication, and finally Examples.

### 1. DEFINITIONS AND CLARIFICATION OF TERMS

Before addressing details of embodiments described below, some terms are defined or clarified.

The term “dopant material” is intended to mean a material, within a layer including a host material, that changes the electronic characteristic(s) or the targeted wavelength(s) of radiation emission, reception, or filtering of the layer compared to the electronic characteristic(s) or the wavelength(s) of radiation emission, reception, or filtering of the layer in the absence of such material.

The term “host material” is intended to mean a material, usually in the form of a layer, to which a dopant material may be added. The host material may or may not have electronic characteristic(s) or the ability to emit, receive, or filter radiation. The dopant material may be added to the host material prior to or subsequent to formation of the layer. In one embodiment, the host material comprises greater than 50% by weight of the layer.

The term “aromatic” as it applied to a compound or group, is intended to mean an organic compound or group comprising at least one unsaturated cyclic group having delocalized pi electrons. The term is intended to encompass both aromatic compounds and groups having only carbon and hydrogen atoms, and heteroaromatic compounds and groups wherein one or more of the carbon atoms within the cyclic group has been replaced by another atom, such as nitrogen, oxygen, sulfur, or the like.

The term “buffer layer” or “buffer material” is intended to mean electrically conductive or semiconductive materials and may have one or more functions in an organic electronic device, including but not limited to, planarization of the underlying layer, charge transport and/or charge injection properties, scavenging of impurities such as oxygen or metal ions, and other aspects to facilitate or to improve the performance of the organic electronic device. Buffer materials may be polymers, oligomers, or small molecules, and may be in the form of solutions, dispersions, suspensions, emulsions, colloidal mixtures, or other compositions.

The term “charge transport,” when referring to a layer, material, member, or structure is intended to mean such layer, material, member, or structure facilitates migration of such charge through the thickness of such layer, material, member, or structure with relative efficiency and small loss of charge. “Hole transport” refers to positive charges. “Electron transport” refers to negative charges.

The term “group” is intended to mean a part of a compound, such as a substituent in an organic compound or a ligand in a metal complex. The prefix “hetero” indicates that one or more carbon atoms have been replaced with a different atom. The prefix “fluoro” indicates that one or more hydrogen atoms have been replaced with a fluorine atom. Examples of substituents include, but are not limited to, alkyl, alkenyl, alkynyl, alkoxy, oxyalkyl, oxyalkenyl, oxyalkynyl, fluorinated alkyl, fluorinated alkenyl, fluorinated oxyalkyl, fluorinated oxyalkenyl, fluorinated oxyalkynyl, aryl, heteroalkyl, heteroalkenyl, heteroalkynyl, heteroaryl, —CN, —OR, —CO₂R, —SR, —N(R)₂, —P(R)₂, —SOR, —SO₂R, and —NO₂; or adjacent groups together can form a 5- or 6-membered cycloalkyl, aryl, or heteroaryl ring, where R is selected from alkyl and aryl.

The term “liquid deposition” refers to the formation of a layer from a liquid material, and includes both continuous and discontinuous deposition techniques. Continuous liquid deposition techniques, include but are not limited to, spin coating, gravure coating, curtain coating, dip coating, slot-die coating, spray coating, and continuous nozzle coating. Discontinuous liquid deposition techniques include, but are not limited to, ink jet printing, gravure printing, and screen printing.

The term “liquid” is intended to include single liquid materials, combinations of liquid materials, and the liquid materials may be in the form of solutions, dispersions, suspensions and emulsions.

The term “layer” is used interchangeably with the term “film” and refers to a coating covering a desired area. The term is not limited by size. The area can be as large as an entire device or as small as a specific functional area such as the actual visual display, or as small as a single sub-pixel.

The term “photoactive” refers to a material that emits light when activated by an applied voltage (such as in a light-emitting diode or light-emitting electrochemical cell), or responds to radiant energy and generates a signal with or without an applied bias voltage (such as in a photodetector). In one embodiment, a photoactive layer is an emitter layer.

The term “polycyclic aromatic” refers to compounds having more than one aromatic ring. The rings may be joined by one or more bonds, or they may be fused together. A fused polycyclic aromatic has two or more rings fused together.

The term “polymer” is intended to mean a material having at least one repeating monomeric unit. The term includes homopolymers having only one kind of monomeric unit, and copolymers having two or more different monomeric units. Copolymers are a subset of polymers. In some embodiments, a polymer has at least 5 repeating units.

The term “small molecule,” when referring to a compound, is intended to mean a compound which does not have repeating monomeric units. In some embodiments, a small molecule has a molecular weight no greater than approximately 2000 g/mol.

The term “electrically conductive polymer” is intended to mean any polymer or oligomer which is inherently or intrinsically capable of electrical conductivity without the addition of carbon black or conductive metal particles. The conductivity of a conductive polymer composition is measured as the lateral conductivity of films made from the composition, in S/cm.

The term “fluorinated acid polymer” is intended to mean a polymer having acidic groups, where at least some of the hydrogens have been replaced by fluorine. The term “acidic group” refers to a group capable of ionizing to donate a hydrogen ion to a Brønsted base.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### 2. DEVICE STRUCTURE

Organic electronic devices that may benefit from having one or more photoactive layers as described herein include, but are not limited to, (1) devices that convert electrical energy into radiation (e.g., a light-emitting diode, light emitting diode display, or diode laser), (2) devices that detect signals through electronics processes (e.g., photodetectors, photoconductive cells, photoresistors, photoswitches, phototransistors, phototubes, IR detectors), (3) devices that convert radiation into electrical energy, (e.g., a photovoltaic device or solar cell), and (4) devices that include one or more electronic components that include one or more organic semi-conductor layers (e.g., a transistor or diode).

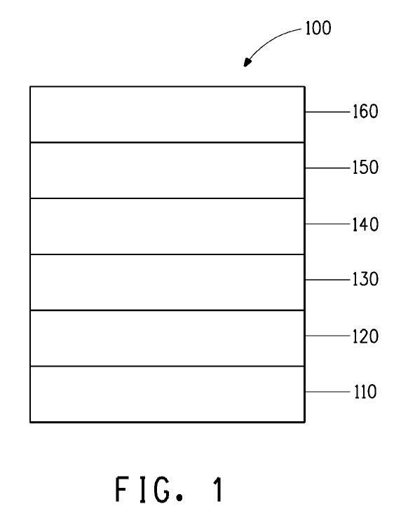

One illustration of an organic electronic device structure is shown in FIG. 1. The device 100 has an anode layer 110 and a cathode layer 160, and a photoactive layer 140 between them. Adjacent to the anode is a buffer layer 120. Adjacent to the buffer layer is a hole transport layer 130, comprising hole transport material. Adjacent to the cathode may be an electron transport layer 150, comprising an electron transport material. As an option, devices may use one or more additional hole injection or hole transport layers (not shown) next to the anode 110 and/or one or more additional electron injection or electron transport layers (not shown) next to the cathode 160.

In one embodiment, the different layers have the following range of thicknesses: anode 110, 500-5000 Å, in one embodiment 1000-2000 Å; buffer layer 120, 50-2000 Å, in one embodiment 200-1000 Å; hole transport layer 120, 50-2000 Å, in one embodiment 200-1000 Å; photoactive layer 130, 10-2000 Å, in one embodiment 100-1000 Å; layer 140, 50-2000 Å, in one embodiment 100-1000 Å; cathode 150, 200-10000 Å, in one embodiment 300-5000 Å. The location of the electron-hole recombination zone in the device, and thus the emission spectrum of the device, can be affected by the relative thickness of each layer. The desired ratio of layer thicknesses will depend on the exact nature of the materials used.

### 3. PHOTOACTIVE LAYER

The photoactive layer comprises a photoactive dopant material and a host material, wherein at least one of the dopant and host is a fused polycyclic aromatic compound. The host and dopant materials can be, independently, small molecule materials or polymeric materials. In some embodiments, both the dopant and host materials are small molecule materials.

Purification of the materials can be accomplished using any known purification technique. These include, but are not limited to, solution purification techniques, such as recrystallization and column chromatography, and vapor sublimation techniques such as batch vapor distillation, train sublimation, ampoule vapor recrystallization, and zone refining. In some embodiments, more than one technique is used. In some embodiments, a combination of solution purification and vapor sublimation is used.

a. Photoactive Dopant Materials

In some embodiments, the photoactive dopant materials are electroluminescent and are selected from materials which have red, green and blue emission colors. Electroluminescent materials include small molecule organic fluorescent compounds, fluorescent and phosphorescent metal complexes, conjugated polymers, and mixtures thereof. Examples of metal complexes include, but are not limited to, metal chelated oxinoid compounds, such as tris(8-hydroxyquinolato)aluminum (AIQ); cyclometalated iridium and platinum electroluminescent compounds, such as complexes of iridium with phenylpyridine, phenylquinoline, or phenylpyrimidine ligands as disclosed in Petrov et al., U.S. Pat. No. 6,670,645 and Published PCT Applications WO 03/063555 and WO 2004/016710, and organometallic complexes described in, for example, Published PCT Applications WO 03/008424, WO 03/091688, and WO 03/040257, and mixtures thereof. Examples of conjugated polymers include, but are not limited to poly(phenylenevinylenes), polyfluorenes, poly(spirobifluorenes), polythiophenes, poly(p-phenylenes), copolymers thereof, and mixtures thereof.

In some embodiments, the EL material is a fused polycyclic aromatic compound. In some embodiments, the EL material has a core structure selected from the group consisting of:

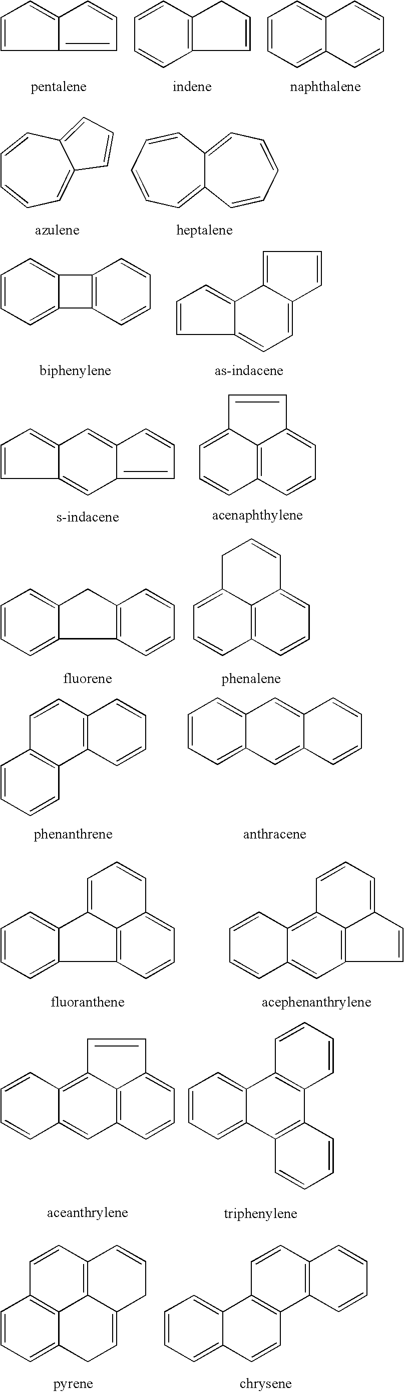

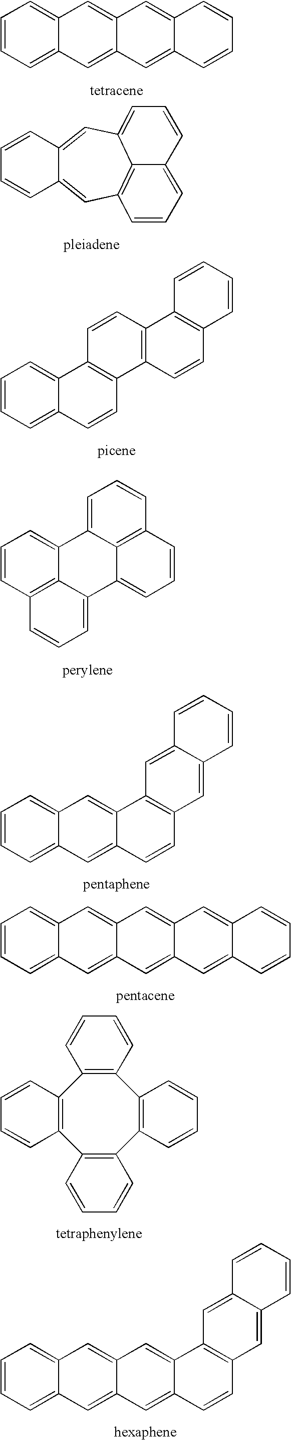

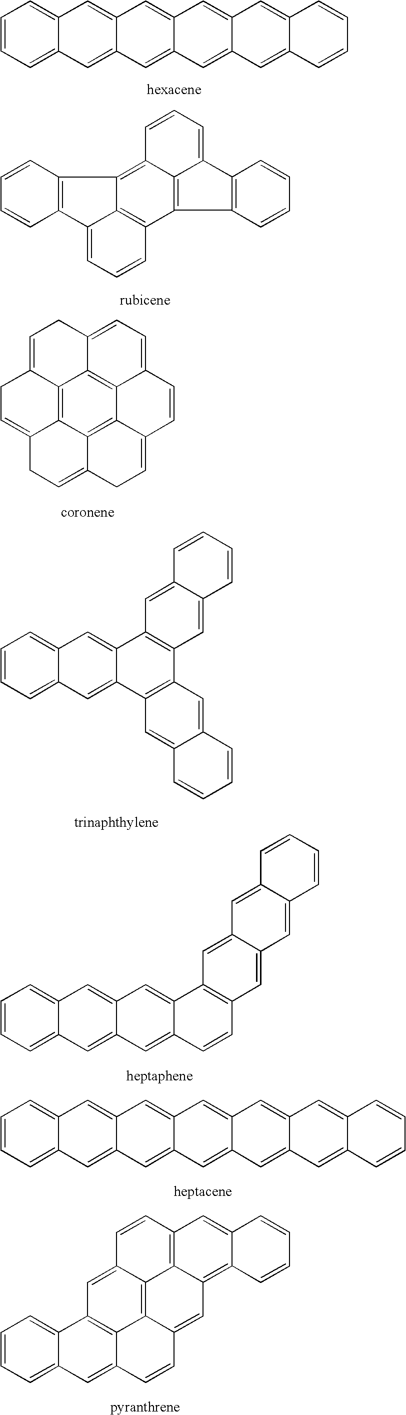

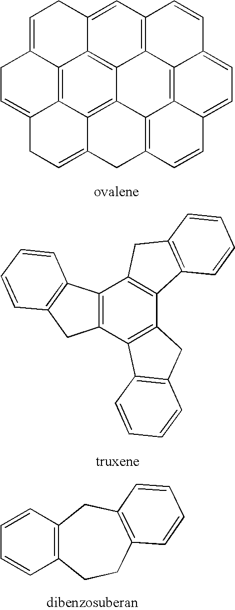

In some embodiments, two or more core structures can be joined together. They may be joined together by simple bonds to form dimeric, oligomeric, or polymeric versions of the core structure. They may be fused together, such as the indenoperylenes and indenopyrenes.

In some embodiments, the core structure may have one or more additional fused aromatic rings, such as benzofluorene.

In some embodiments, some of the core may be hydrogenated, such as tetrahydropyrene and hexahydropyrene. In some embodiments, the core is 1,2,3,6,7,8-hexahydropyrene. Accordingly, the use of core group nomenclature is intended to include hydrogenated forms of the core groups.

In some embodiments, the core contains at least one heterocyclic ring, where a CH is replaced by N, or a CH₂ is replaced by O, S, or NR, where R is an alkyl or aryl group.

The core fused polycyclic aromatic structure can be unsubstituted or substituted. Examples of substituents include, but are not limited to alkyl, alkenyl, alkynyl, alkoxy, oxyalkyl, oxyalkenyl, oxyalkynyl, fluorinated alkyl, fluorinated alkenyl, fluorinated oxyalkyl, fluorinated oxyalkenyl, fluorinated oxyalkynyl, aryl, heteroalkyl, heteroalkenyl, heteroalkynyl, heteroaryl, —CN, —OR, —CO₂R, —SR, —N(R)₂, —P(R)₂, —SOR, —SO₂R, —NO₂, —R³—OH, —CH₂—C₆H₅, —R³—C(O)O-Z, —R³—O—R⁵, —R³—O—R⁴—C(O)O-Z, —R³—O—R⁴—SO₃Z, and —R³—O—C(O)—N(R⁶)₂; where all “R” groups are the same or different at each occurrence and:
R is selected from alkyl and aryl
R³ is a single bond or an alkylene group
R⁴ is an alkylene group
R⁵ is an alkyl group
R⁶ is hydrogen or an alkyl group

Z is H, Li, Na, K, N(R⁵)₄ or R⁵.

Any of the above groups may further be unsubstituted or substituted, and any group may have F substituted for one or more hydrogens, including perfluorinated groups.

In some embodiments, the EL material is a fused polycyclic aromatic compound having at least one substituent selected from the group consisting of alkyl, aryl, arylamine, and combinations thereof. In some embodiments, the compound has at least two diarylamine substituents. In some embodiments, the diarylamine is a carbazole or substituted carbazole group. In some embodiments, the diarylamine has aryl groups which are selected from phenyl, naphthyl, anthracenyl, and combinations thereof.

In some embodiments, the core structure of the EL materials has at least three fused rings. In some embodiments, the core structure is selected from the group consisting of naphthalene, anthracene, chrysene, pyrene, tetracene, and perylene.

In some embodiments, the EL material has a core selected from the group consisting of anthracene, chrysene, pyrene, tetrahydropyrene,

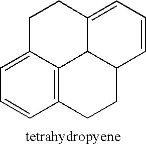

and hexahydropyrene,

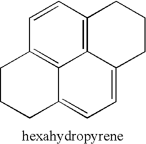

wherein the core has at least one substituent. In one embodiment, the core has at least one diarylamino substituent and at least one second substituent selected from the group consisting of alkyl, fluoro, fluoroalkyl, alkoxy, fluoroalkoxy, aryloxy, fluoroaryloxy, fluoroalkylaryloxy, aryl, fluoroaryl, and fluoroalkylaryl.

In some embodiments, the EL material has a core which is a perylene having at least one substituent selected from the group consisting of amino, alkyl, fluoro, fluoroalkyl, alkoxy, fluoroalkoxy, aryloxy, fluoroaryloxy, fluoroalkylaryloxy, aryl, fluoroaryl, and fluoroalkylaryl. In one embodiment, the substituent is an alky or aryl group.

In some embodiments, the EL material is selected from the group consisting of:

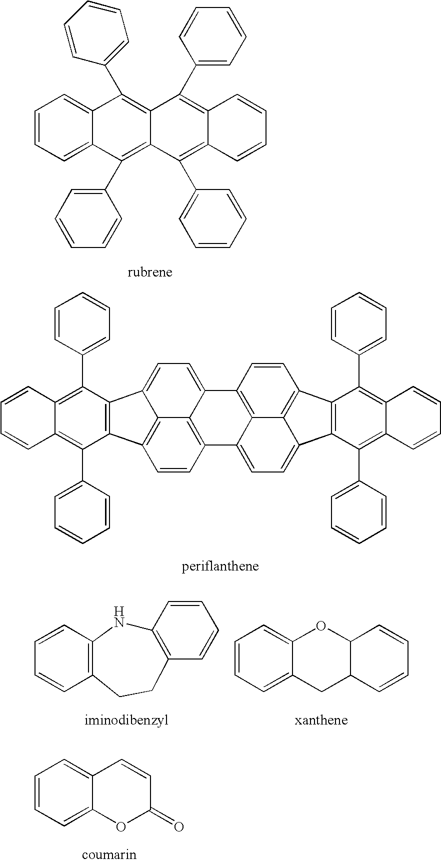

and
boron, [(1,2-dihydro-2,2′-methylidynediquinolinato)(1-)]difluoro derivatives

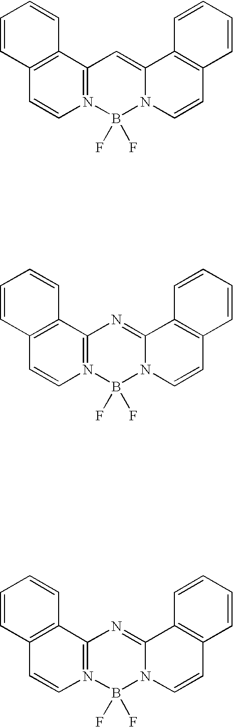

The above EL materials have at least one substituent selected from the group consisting of amino, alkyl, fluoro, fluoroalkyl, alkoxy, fluoroalkoxy, aryloxy, fluoroaryloxy, fluoroalkylaryloxy, aryl, fluoroaryl, and fluoroalkylaryl.
b. Host Materials

In some embodiments, the host material is a fused polycyclic aromatic compound. In some embodiments, the host material has a core structure selected from the group consisting of:

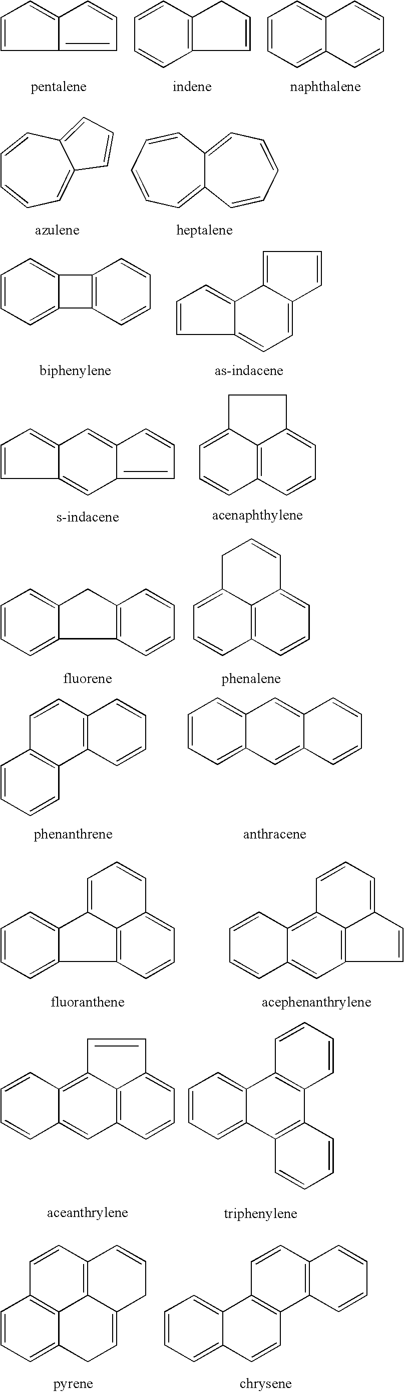

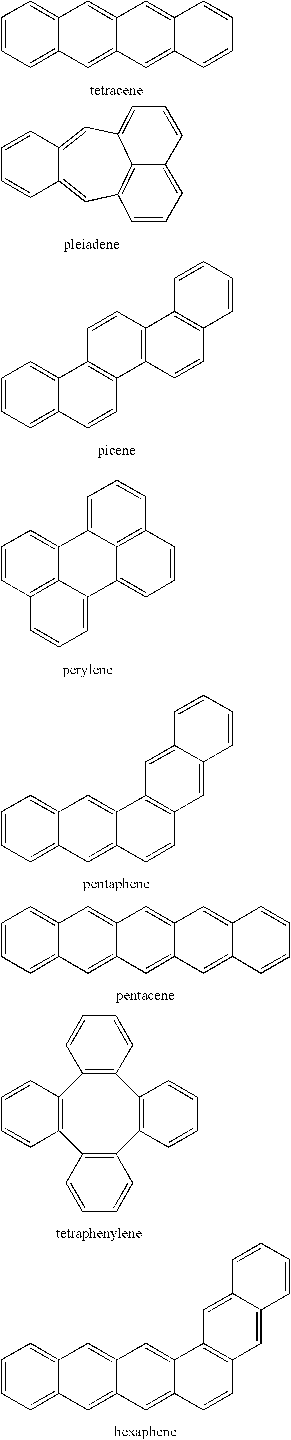

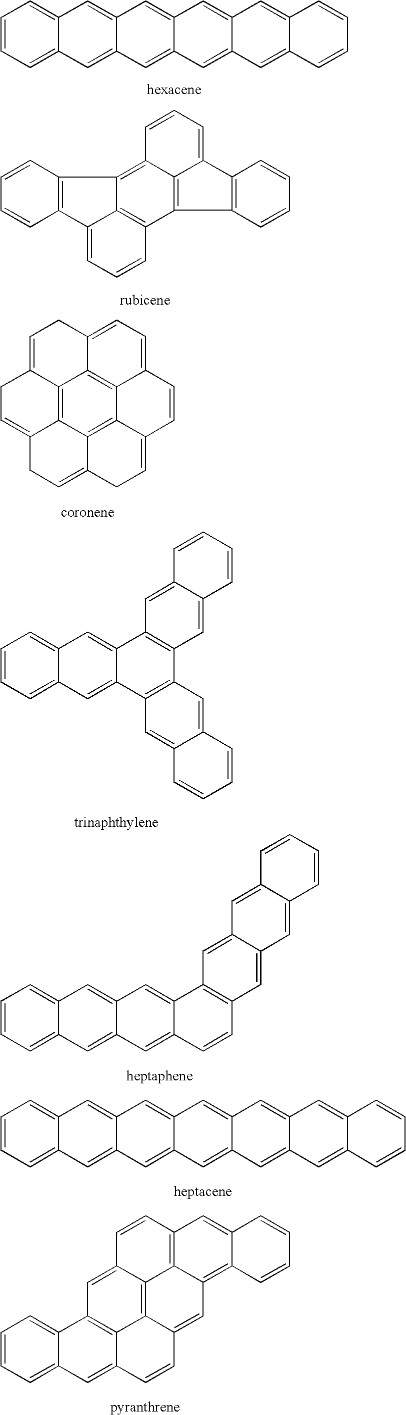

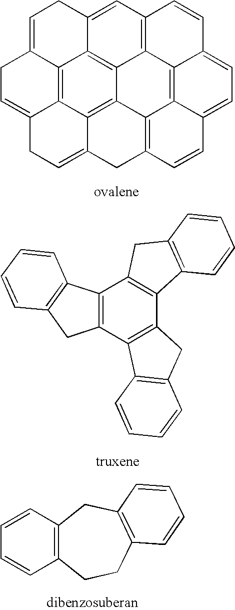

In some embodiments, two or more core structures can be joined together. They may be joined together by simple bonds to form dimeric, oligomeric, or polymeric versions of the core structure. They may be fused together, such as the indenoperylenes and indenopyrenes.

In some embodiments, the core structure may have one or more additional fused aromatic rings, such as benzofluorene.

In some embodiments, some of the core may be hydrogenated, such as tetrahydropyrene and hexahydropyrene.

In some embodiments, the core contains at least one heterocyclic ring, where a CH is replaced by N, or a CH₂ is replaced by O, S, or NR, where R is an alkyl or aryl group.

The core fused polycyclic aromatic structure can be unsubstituted or substituted. Examples of substituents include, but are not limited to halogen, alkyl, alkenyl, alkynyl, alkoxy, oxyalkyl, oxyalkenyl, oxyalkynyl, fluorinated alkyl, fluorinated alkenyl, fluorinated oxyalkyl, fluorinated oxyalkenyl, fluorinated oxyalkynyl, aryl, heteroalkyl, heteroalkenyl, heteroalkynyl, heteroaryl, —CN, —OR, —CO₂R, —SR, —N(R)₂, —P(R)₂, —SOR, —SO₂R, —NO₂, —R³—OH, —CH₂—C₆H₅, —R³—C(O)O-Z, —R³—O—R⁵, —R³—O—R⁴—C(O)O-Z, —R³—O—R⁴—SO₃Z, and —R³—O—C(O)—N(R⁶)₂; where all “R” groups are the same or different at each occurrence and:
R is selected from alkyl and aryl
R³ is a single bond or an alkylene group
R⁴ is an alkylene group
R⁵ is an alkyl group
R⁶ is hydrogen or an alkyl group
Z is H, Li, Na, K, N(R⁵)₄ or R⁵.
   Any of the above groups may further be unsubstituted or substituted, and any group may have F substituted for one or more hydrogens, including perfluorinated groups.

In some embodiments, the host material is a fused polycyclic aromatic compound having at least one substituent selected from the group consisting of alkyl, aryl, and combinations thereof.

In some embodiments, the host material has a core structure selected from the group consisting of pentalene, indene, naphthalene, azulene, heptalene, biphenylene, as-indacene, s-indacene, acenaphthylene, fluorene, phenalene, phenanthrene, anthracene, fluoranthene, acephenanthrylene, aceanthrylene, triphenylene, pyrene, chrysene, napthacene, perylene, and tetraphenylene.

In some embodiments, the host has an anthracene core structure. In some embodiments the host has the formula:

An-L-An

where:

An is an anthracene moiety;

L is a divalent connecting group.

In some embodiments of this formula, L is a single bond, —O—, —S—, —N(R)—, or an aromatic group. In some embodiments, An is a mono- or diphenylanthryl moiety.

In some embodiments, the host has the formula:

A-An-A

where:

An is an anthracene moiety;

A is an aromatic group.

In some embodiments, the host is a diarylanthracene. In some embodiments the compound is symmetrical and in some embodiments the compound is non-symmetrical.

In some embodiments, the host has the formula:

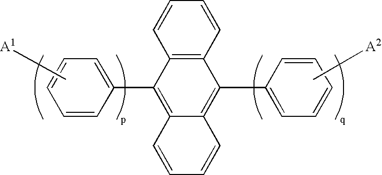

where:

A¹ and A² are the same or different at each occurrence and are selected from the group consisting of H, an aromatic group, and an alkenyl group, or A may represent one or more fused aromatic rings;

p and q are the same or different and are an integer from 1-3. In some embodiments, the anthracene derivative is non-symmetrical. In some embodiments, p=2 and q=1. In some embodiments, at least one of A¹ and A² is a naphthyl group.

In some embodiments, the host has a core structure selected from the group consisting of fluorene, naphthalene, pyrene, perylene, chrysene, tetrahydropyrene, and hexahydropyrene, wherein there is at least one substituent selected from the group consisting of alkyl, fluoro, fluoroalkyl, alkoxy, fluoroalkoxy, aryloxy, fluoroaryloxy, fluoroalkylaryloxy, aryl, fluoroaryl, and fluoroalkylaryl.

In some embodiments, the host can be used in combination with another host as the emitter in a photoactive layer.

### 4. HOLE TRANSPORT LAYER

Examples of hole transport materials for the hole transport layer have been summarized for example, in Kirk-Othmer Encyclopedia of Chemical Technology, Fourth Edition, Vol. 18, p. 837-860, 1996, by Y. Wang. Both hole transporting small molecules and polymers can be used. Commonly used hole transporting molecules include, but are not limited to: 4,4′,4″-tris(N,N-diphenyl-amino)-triphenylamine (TDATA); 4,4′,4″-tris(N-3-methylphenyl-N-phenyl-amino)-triphenylamine (MTDATA); N,N′-diphenyl-N,N′-bis(3-methylphenyl)-[1,1′-biphenyl]-4,4′-diamine (TPD); 4,4′-bis(carbazol-9-yl)biphenyl (CBP); 1,3-bis(carbazol-9-yl)benzene (mCP); 1,1-bis[(di-4-tolylamino) phenyl]cyclohexane (TAPC); N,N′-bis(4-methylphenyl)-N,N′-bis(4-ethylphenyl)-[1,1′-(3,3′-dimethyl)biphenyl]-4,4′-diamine (ETPD); tetrakis-(3-methylphenyl)-N,N,N′,N′-2,5-phenylenediamine (PDA); α-phenyl-4-N,N-diphenylaminostyrene (TPS); p-(diethylamino)benzaldehyde diphenylhydrazone (DEH); triphenylamine (TPA); bis[4-(N,N-diethylamino)-2-methylphenyl](4-methylphenyl)methane (MPMP); 1-phenyl-3-[p-(diethylamino)styryl]-5-[p-(diethylamino)phenyl]pyrazoline (PPR or DEASP); 1,2-trans-bis(9H-carbazol-9-yl)cyclobutane (DCZB); N,N,N′,N′-tetrakis(4-methylphenyl)-(1,1′-biphenyl)-4,4′-diamine (TTB); N,N′-bis(naphthalen-1-yl)-N,N′-bis-(phenyl)benzidine (α-NPB); and porphyrinic compounds, such as copper phthalocyanine. Commonly used hole transporting polymers include, but are not limited to, polyvinylcarbazole, (phenylmethyl)polysilane, poly(dioxythiophenes), polyanilines, and polypyrroles. It is also possible to obtain hole transporting polymers by doping hole transporting molecules such as those mentioned above into polymers such as polystyrene and polycarbonate.

In some embodiments, the hole transport layer comprises a hole transport polymer. In some embodiments, the hole transport polymer is a distyrylaryl compound. In some embodiments, the aryl group is has two or more fused aromatic rings. In some embodiments, the aryl group is an acene. The term “acene” as used herein refers to a hydrocarbon parent component that contains two or more ortho-fused benzene rings in a straight linear arrangement.

In some embodiments, the hole transport polymer is an arylamine polymer. In some embodiments, it is a copolymer of fluorene and arylamine monomers.

In some embodiments, the polymer has crosslinkable groups. In some embodiments, crosslinking can be accomplished by a heat treatment and/or exposure to UV or visible radiation. Examples of crosslinkable groups include, but are not limited to vinyl, acrylate, perfluorovinylether, 1-benzo-3,4-cyclobutane, siloxane, and methyl esters. Crosslinkable polymers can have advantages in the fabrication of solution-process OLEDs. The application of a soluble polymeric material to form a layer which can be converted into an insoluble film subsequent to deposition, can allow for the fabrication of multilayer solution-processed OLED devices free of layer dissolution problems.

Examples of crosslinkable polymers can be found in, for example, published US patent application 2005-0184287 and published PCT application WO 2005/052027.

In some embodiments, the hole transport layer comprises a polymer which is a copolymer of 9,9-dialkylfluorene and triphenylamine. In some embodiments, the polymer is a copolymer of 9,9-dialkylfluorene and 4,4′-bis(diphenylamino)biphenyl. In some embodiments, the polymer is a copolymer of 9,9-dialkylfluorene and TPB. In some embodiments, the polymer is a copolymer of 9,9-dialkylfluorene and NPB. In some embodiments, the copolymer is made from a third comonomer selected from (vinylphenyl)diphenylamine and 9,9-distyrylfluorene or 9,9-di(vinylbenzyl)fluorene.

In some embodiments, the hole transport layer comprises a polymer having Formula I:

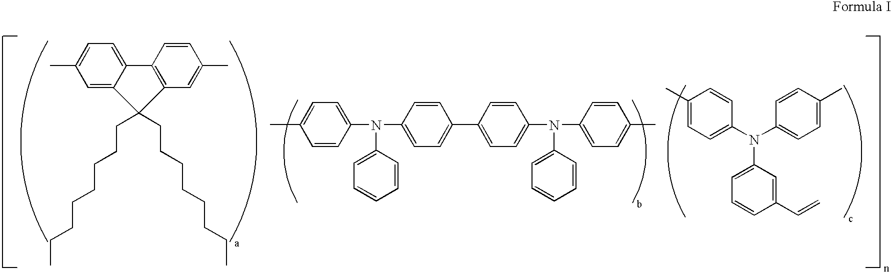

where a, b, and c represent the relative proportion of monomers in the polymer and are non-zero integers; n is a non-zero integer of at least 2. In some embodiments, a, b, and c have values in the range of 1-10. In some embodiments, the ratio a:b:c has the ranges (1-4):(1-4):(1-2). In some embodiments, n is 2-500.

In some embodiments, the hole transport layer comprises a polymer having Formula II:

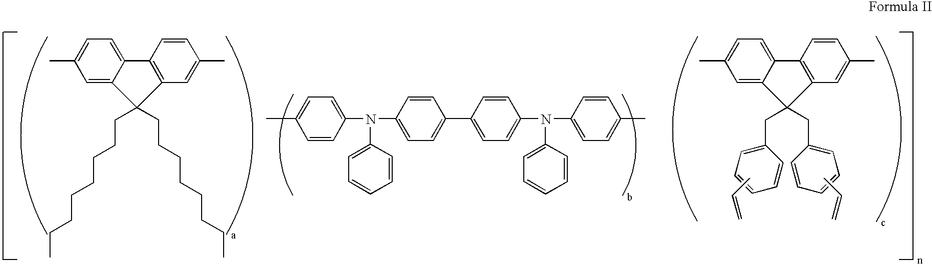

where a, b, and c represent the relative proportion of monomers in the polymer and are non-zero integers; n is a non-zero integer of at least 2. In some embodiments, a, b, and c have values in the range of 0.001-10. In some embodiments, the ratio a:b:c has the ranges (2-7):(2-7):(1-3). In some embodiments, n is 2-500.

The polymers for the hole transport layer, in particular, polymers having Formula I or Formula II, can generally be prepared by three known synthetic routes. In a first synthetic method, as described in Yamamoto, Progress in Polymer Science, Vol. 17, p 1153 (1992), the dihalo or ditriflate derivatives of the monomeric units are reacted with a stoichiometric amount of a zerovalent nickel compound, such as bis(1,5-cyclooctadiene)nickel(0). In the second method, as described in Colon et al., Journal of Polymer Science, Part A, Polymer chemistry Edition, Vol. 28, p. 367 (1990). The dihalo or ditriflate derivatives of the monomeric units are reacted with catalytic amounts of Ni(II) compounds in the presence of stoichiometric amounts of a material capable of reducing the divalent nickel ion to zerovalent nickel. Suitable materials include zinc, magnesium, calcium and lithium. In the third synthetic method, as described in U.S. Pat. No. 5,962,631, and published PCT application WO 00/53565, a dihalo or ditriflate derivative of one monomeric unit is reacted with a derivative of another monomeric unit having two reactive groups selected from boronic acid, boronic acid esters, and boranes, in the presence of a zerovalent or divalent palladium catalyst, such as tetrakis(triphenylphosphine)Pd or Pd(OAc)₂.

In some embodiments, the hole transport layer comprises a polymer selected from the group consisting of P1 through P11:

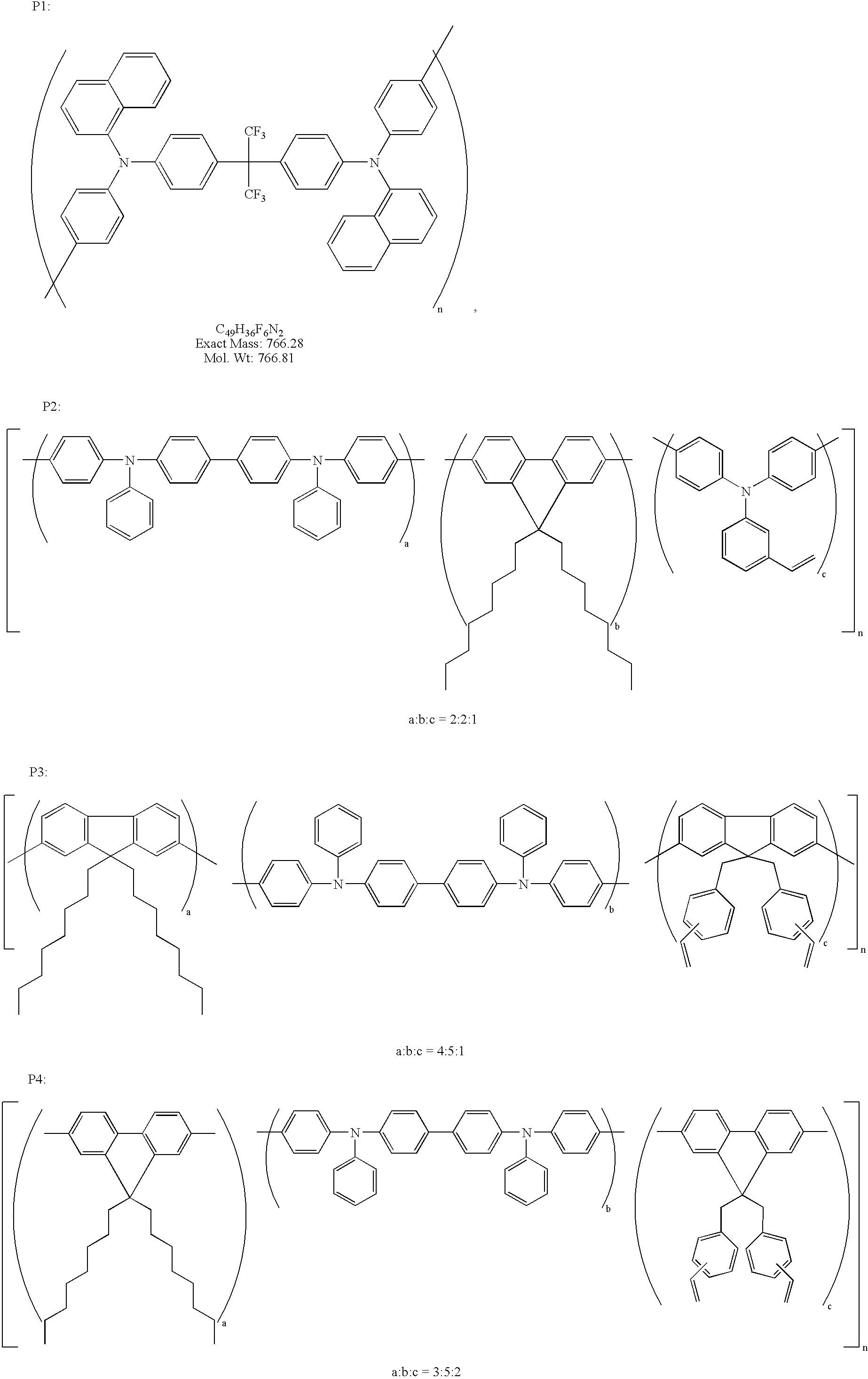

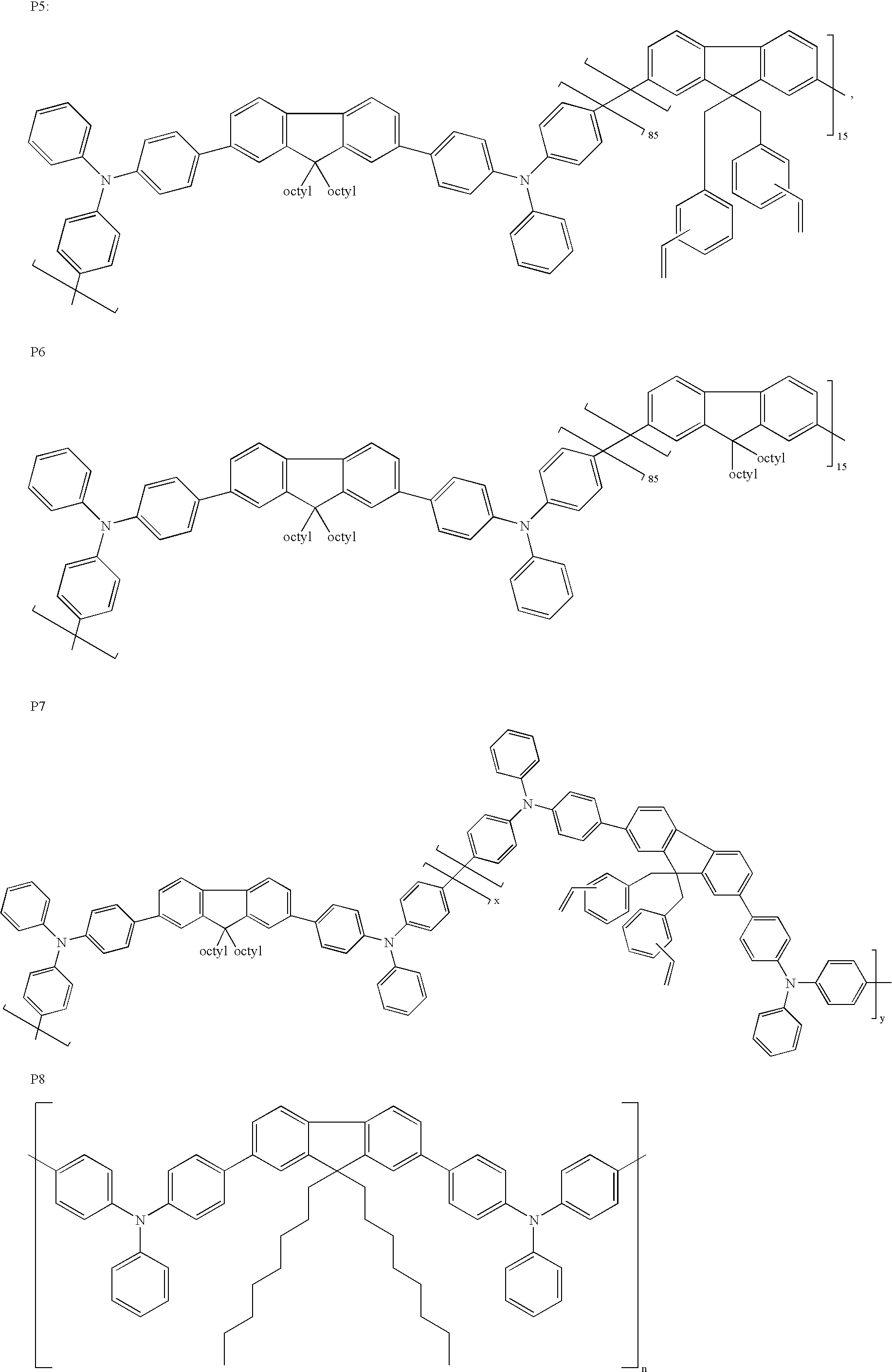

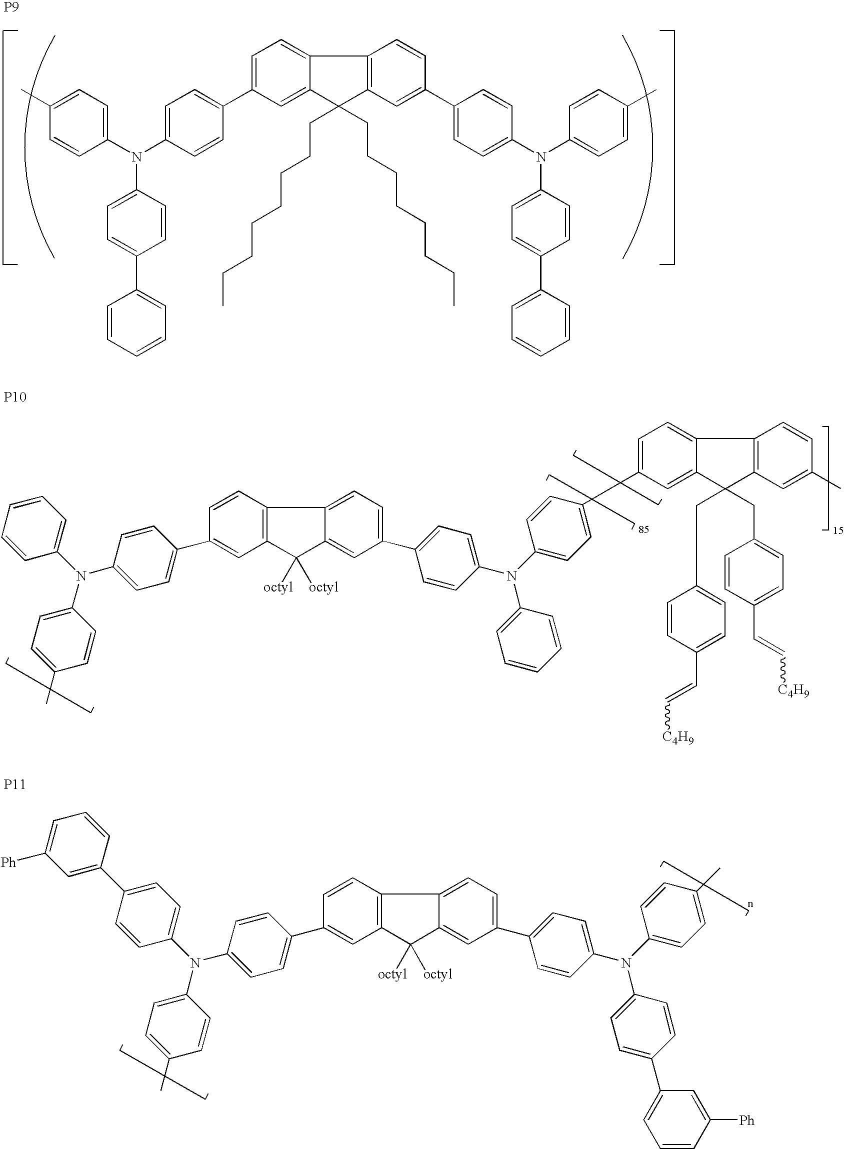

In some embodiments, the hole transport layer comprises a polymer selected from the group consisting of P2 through P5 and P7 which has been crosslinked subsequent to the formation of the layer.

In some embodiments, the hole transport layer comprises a polymer selected from the group consisting of P1 and P6, P8, P9, or P11, which has been heated subsequent to the formation of the layer.

### 5. BUFFER LAYER

The buffer layer can be formed with polymeric materials, such as polyaniline (PANI) or polyethylenedioxythiophene (PEDOT), which are often doped with protonic acids. The protonic acids can be, for example, poly(styrenesulfonic acid), poly(2-acrylamido-2-methyl-1-propanesulfonic acid), and the like.

The buffer layer can comprise charge transfer compounds, and the like, such as copper phthalocyanine and the tetrathiafulvalene-tetracyanoquinodimethane system (TTF-TCNQ).

In some embodiments, the buffer layer comprises at least one electrically conductive polymer and at least one fluorinated acid polymer.

In some embodiments, the electrically conductive polymer will form a film which has a conductivity of at least 10⁻⁷ S/cm. The monomer from which the conductive polymer is formed, is referred to as a “precursor monomer”. A copolymer will have more than one precursor monomer. In some embodiments, the conductive polymer is made from at least one precursor monomer selected from thiophenes, selenophenes, tellurophenes, pyrroles, anilines, and polycyclic aromatics. The polymers made from these monomers are referred to herein as polythiophenes, poly(selenophenes), poly(tellurophenes), polypyrroles, polyanilines, and polycyclic aromatic polymers, respectively. The term “polycyclic aromatic” refers to compounds having more than one aromatic ring. The rings may be joined by one or more bonds, or they may be fused together. The term “aromatic ring” is intended to include heteroaromatic rings. A “polycyclic heteroaromatic” compound has at least one heteroaromatic ring. In some embodiments, the polycyclic aromatic polymers are poly(thienothiophenes).

The fluorinated acid polymer can be any polymer which is fluorinated and has acidic groups with acidic protons. The term includes partially and fully fluorinated materials. In some embodiments, the fluorinated acid polymer is highly fluorinated. The term “highly fluorinated” means that at least 50% of the available hydrogens bonded to a carbon, have been replaced with fluorine. The acidic groups supply an ionizable proton. In some embodiments, the acidic proton has a pKa of less than 3. In some embodiments, the acidic proton has a pKa of less than 0. In some embodiments, the acidic proton has a pKa of less than −5. The acidic group can be attached directly to the polymer backbone, or it can be attached to side chains on the polymer backbone. Examples of acidic groups include, but are not limited to, carboxylic acid groups, sulfonic acid groups, sulfonimide groups, phosphoric acid groups, phosphonic acid groups, and combinations thereof. The acidic groups can all be the same, or the polymer may have more than one type of acidic group.

In some embodiments the fluorinated acid polymer is water-soluble. In some embodiments, the fluorinated acid polymer is dispersible in water. In some embodiments, the fluorinated acid polymer is organic solvent wettable.

In some embodiments, fluorinated acid polymer has a polymer backbone which is fluorinated. Examples of suitable polymeric backbones include, but are not limited to, polyolefins, polyacrylates, polymethacrylates, polyimides, polyamides, polyaramids, polyacrylamides, polystyrenes, and copolymers thereof. In some embodiments, the polymer backbone is highly fluorinated. In some embodiments, the polymer backbone is fully fluorinated.

In some embodiments, the acidic groups are sulfonic acid groups or sulfonimide groups. A sulfonimide group has the formula:

—SO₂—NH—SO₂—R

where R is an alkyl group.

In some embodiments, the acidic groups are on a fluorinated side chain. In some embodiments, the fluorinated side chains are selected from alkyl groups, alkoxy groups, amido groups, ether groups, and combinations thereof.

In some embodiments, the fluorinated acid polymer has a fluorinated olefin backbone, with pendant fluorinated ether sulfonate, fluorinated ester sulfonate, or fluorinated ether sulfonimide groups. In some embodiments, the polymer is a copolymer of 1,1-difluoroethylene and 2-(1,1-difluoro-2-(trifluoromethyl)allyloxy)-1,1,2,2-tetrafluoroethanesulfonic acid. In some embodiments, the polymer is a copolymer of ethylene and 2-(2-(1,2,2-trifluorovinyloxy)-1,1,2,3,3,3-hexafluoropropoxy)-1,1,2,2-tetrafluoroethanesulfonic acid. These copolymers can be made as the corresponding sulfonyl fluoride polymer and then can be converted to the sulfonic acid form.

In some embodiments, the fluorinated acid polymer is homopolymer or copolymer of a fluorinated and partially sulfonated poly(arylene ether sulfone). The copolymer can be a block copolymer. Examples of comonomers include, but are not limited to butadiene, butylene, isobutylene, styrene, and combinations thereof.

In some embodiments, the buffer layer is made from an aqueous dispersion of an electrically conducting polymer and a colloid-forming polymeric acid. Such materials have been described in, for example, published U.S. patent applications 2004-0102577, 2004-0127637, and 2005-0205860.

### 6. OTHER DEVICE LAYERS

The other layers in the device can be made of any materials which are known to be useful in such layers. The anode is an electrode that is particularly efficient for injecting positive charge carriers. It can be made of, for example materials containing a metal, mixed metal, alloy, metal oxide or mixed-metal oxide, or it can be a conducting polymer, and mixtures thereof. Suitable metals include the Group 11 metals, the metals in Groups 4, 5, and 6, and the Group 8-10 transition metals. If the anode is to be light-transmitting, mixed-metal oxides of Groups 12, 13 and 14 metals, such as indium-tin-oxide, are generally used. The anode may also comprise an organic material such as polyaniline as described in “Flexible light-emitting diodes made from soluble conducting polymer,” Nature vol. 357, pp 477 479 (11 Jun. 1992). At least one of the anode and cathode should be at least partially transparent to allow the generated light to be observed.

Examples of electron transport materials which can be used in the optional electron transport layer 140, include metal chelated oxinoid compounds, such as tris(8-hydroxyquinolato)aluminum (AIQ), bis(2-methyl-8-quinolinolato)(p-phenylphenolato) aluminum (BAlq), and tetrakis-(8-hydroxyquinolato)zirconium (ZrQ); and azole compounds such as 2-(4-biphenylyl)-5-(4-t-butylphenyl)-1,3,4-oxadiazole (PBD), 3-(4-biphenylyl)-4-phenyl-5-(4-t-butylphenyl)-1,2,4-triazole (TAZ), and 1,3,5-tri(phenyl-2-benzimidazole)benzene (TPBI); quinoxaline derivatives such as 2,3-bis(4-fluorophenyl)quinoxaline; phenanthrolines such as 4,7-diphenyl-1,10-phenanthroline (DPA) and 2,9-dimethyl-4,7-diphenyl-1,10-phenanthroline (DDPA); and mixtures thereof.

The cathode, is an electrode that is particularly efficient for injecting electrons or negative charge carriers. The cathode can be any metal or nonmetal having a lower work function than the anode. Materials for the cathode can be selected from alkali metals of Group 1 (e.g., Li, Cs), the Group 2 (alkaline earth) metals, the Group 12 metals, including the rare earth elements and lanthanides, and the actinides. Materials such as aluminum, indium, calcium, barium, samarium and magnesium, as well as combinations, can be used. Li-containing organometallic compounds, LiF, and Li₂O can also be deposited between the organic layer and the cathode layer to lower the operating voltage. This layer may be referred to as an electron injection layer.

### 7. DEVICE FABRICATION

In some embodiments, the device is fabricated by liquid deposition of the buffer layer, the hole transport layer, and the photoactive layer, and by vapor deposition of the anode, the electron transport layer, an electron injection layer and the cathode.

The buffer layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is selected from the group consisting of alcohols, ketones, cyclic ethers, and polyols. In one embodiment, the organic liquid is selected from dimethylacetamide (“DMAc”), N-methylpyrrolidone (“NMP”), dimethylformamide (“DMF”), ethylene glycol (“EG”), aliphatic alcohols, and mixtures thereof. The buffer material can be present in the liquid medium in an amount from 0.5 to 10 percent by weight. Other weight percentages of buffer material may be used depending upon the liquid medium. The buffer layer can be applied by any continuous or discontinuous liquid deposition technique. In one embodiment, the buffer layer is applied by spin coating. In one embodiment, the buffer layer is applied by ink jet printing. After liquid deposition, the liquid medium can be removed in air, in an inert atmosphere, or by vacuum, at room temperature or with heating. In one embodiment, the layer is heated to a temperature less than 275° C. In one embodiment, the heating temperature is between 100° C. and 275° C. In one embodiment, the heating temperature is between 100° C. and 120° C. In one embodiment, the heating temperature is between 120° C. and 140° C. In one embodiment, the heating temperature is between 140° C. and 160° C. In one embodiment, the heating temperature is between 160° C. and 180° C. In one embodiment, the heating temperature is between 180° C. and 200° C. In one embodiment, the heating temperature is between 200° C. and 220° C. In one embodiment, the heating temperature is between 190° C. and 220° C. In one embodiment, the heating temperature is between 220° C. and 240° C. In one embodiment, the heating temperature is between 240° C. and 260° C. In one embodiment, the heating temperature is between 260° C. and 275° C. The heating time is dependent upon the temperature, and is generally between 5 and 60 minutes. In one embodiment, the final layer thickness is between 5 and 200 nm. In one embodiment, the final layer thickness is between 5 and 40 nm. In one embodiment, the final layer thickness is between 40 and 80 nm. In one embodiment, the final layer thickness is between 80 and 120 nm. In one embodiment, the final layer thickness is between 120 and 160 nm. In one embodiment, the final layer thickness is between 160 and 200 nm.

The hole transport layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is an aromatic solvent. In one embodiment, the organic liquid is selected from chloroform, dichloromethane, toluene, xylene, mesitylene, anisole, and mixtures thereof. The hole transport material can be present in the liquid medium in a concentration of 0.2 to 2 percent by weight. Other weight percentages of hole transport material may be used depending upon the liquid medium. The hole transport layer can be applied by any continuous or discontinuous liquid deposition technique. In one embodiment, the hole transport layer is applied by spin coating. In one embodiment, the hole transport layer is applied by ink jet printing. After liquid deposition, the liquid medium can be removed in air, in an inert atmosphere, or by vacuum, at room temperature or with heating. In one embodiment, the layer is heated to a temperature of 300° C. or less. In one embodiment, the heating temperature is between 170° C. and 275° C. In one embodiment, the heating temperature is between 170° C. and 200° C. In one embodiment, the heating temperature is between 190° C. and 220° C. In one embodiment, the heating temperature is between 210° C. and 240° C. In one embodiment, the heating temperature is between 230° C. and 270° C. In one embodiment, the heating temperature is between 270° C. and 300° C. The heating time is dependent upon the temperature, and is generally between 5 and 60 minutes. In one embodiment, the final layer thickness is between 5 and 50 nm. In one embodiment, the final layer thickness is between 5 and 15 nm. In one embodiment, the final layer thickness is between 15 and 25 nm. In one embodiment, the final layer thickness is between 25 and 35 nm. In one embodiment, the final layer thickness is between 35 and 50 nm.

The photoactive layer can be deposited from any liquid medium in which it is dissolved or dispersed and from which it will form a film. In one embodiment, the liquid medium consists essentially of one or more organic solvents. In one embodiment, the liquid medium consists essentially of water or water and an organic solvent. In one embodiment the organic solvent is an aromatic solvent. In one embodiment, the organic solvent is selected from chloroform, dichloromethane, toluene, anisole, 2-butanone, 3-pentanone, butyl acetate, acetone, xylene, mesitylene, chlorobenzene, tetrahydrofuran, diethyl ether, trifluorotoluene, and mixtures thereof. The photoactive material can be present in the liquid medium in a concentration of 0.2 to 2 percent by weight. Other weight percentages of photoactive material may be used depending upon the liquid medium. The photoactive layer can be applied by any continuous or discontinuous liquid deposition technique. In one embodiment, the photoactive layer is applied by spin coating. In one embodiment, the photoactive layer is applied by ink jet printing. After liquid deposition, the liquid medium can be removed in air, in an inert atmosphere, or by vacuum, at room temperature or with heating. Optimal baking conditions depend on the vapor pressure properties of the liquids being removed and their molecular interaction with the liquids. In one embodiment, the deposited layer is heated to a temperature that is greater than the Tg of the material having the highest Tg. In one embodiment, the deposited layer is heated between 10 and 20° C. higher than the Tg of the material having the highest Tg. In one embodiment, the deposited layer is heated to a temperature that is less than the Tg of the material having the lowest Tg. In one embodiment, the heating temperature is at least 10° C. less than the lowest Tg. In one embodiment, the heating temperature is at least 20° C. less than the lowest Tg. In one embodiment, the heating temperature is at least 30° C. less than the lowest Tg. In one embodiment, the heating temperature is between 50° C. and 150° C. In one embodiment, the heating temperature is between 50° C. and 75° C. In one embodiment, the heating temperature is between 75° C. and 100° C. In one embodiment, the heating temperature is between 100° C. and 125° C. In one embodiment, the heating temperature is between 125° C. and 150° C. The heating time is dependent upon the temperature, and is generally between 5 and 60 minutes. In one embodiment, the final layer thickness is between 25 and 100 nm. In one embodiment, the final layer thickness is between 25 and 40 nm. In one embodiment, the final layer thickness is between 40 and 65 nm. In one embodiment, the final layer thickness is between 65 and 80 nm. In one embodiment, the final layer thickness is between 80 and 100 nm.

The electron transport layer can be deposited by any vapor deposition method. In one embodiment, it is deposited by thermal evaporation under vacuum. In one embodiment, the final layer thickness is between 1 and 100 nm. In one embodiment, the final layer thickness is between 1 and 15 nm. In one embodiment, the final layer thickness is between 15 and 30 nm. In one embodiment, the final layer thickness is between 30 and 45 nm. In one embodiment, the final layer thickness is between 45 and 60 nm. In one embodiment, the final layer thickness is between 60 and 75 nm. In one embodiment, the final layer thickness is between 75 and 90 nm. In one embodiment, the final layer thickness is between 90 and 100 nm.

The electron injection layer can be deposited by any vapor deposition method. In one embodiment, it is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. The vapor deposition rates given herein are in units of Angstroms per second. In one embodiment, the material is deposited at a rate of 0.5 to 10 \acute{Å}/sec. In one embodiment, the material is deposited at a rate of 0.5 to 1 \acute{Å}/sec. In one embodiment, the material is deposited at a rate of 1 to 2 \acute{Å}/sec. In one embodiment, the material is deposited at a rate of 2 to 3 \acute{Å}/sec. In one embodiment, the material is deposited at a rate of 3 to 4 \acute{Å}/sec. In one embodiment, the material is deposited at a rate of 4 to 5 \acute{Å}/sec. In one embodiment, the material is deposited at a rate of 5 to 6 \acute{Å}/sec. In one embodiment, the material is deposited at a rate of 6 to 7 \acute{Å}/sec. In one embodiment, the material is deposited at a rate of 7 to 8 \acute{Å}/sec. In one embodiment, the material is deposited at a rate of 8 to 9 \acute{Å}/sec. In one embodiment, the material is deposited at a rate of 9 to 10 \acute{Å}/sec. In one embodiment, the final layer thickness is between 0.1 and 3 nm. In one embodiment, the final layer thickness is between 0.1 and 1 nm. In one embodiment, the final layer thickness is between 1 and 2 nm. In one embodiment, the final layer thickness is between 2 and 3 nm.

The cathode can be deposited by any vapor deposition method. In one embodiment, it is deposited by thermal evaporation under vacuum. In one embodiment, the vacuum is less than 10⁻⁶ torr. In one embodiment, the vacuum is less than 10⁻⁷ torr. In one embodiment, the vacuum is less than 10⁻⁸ torr. In one embodiment, the material is heated to a temperature in the range of 100° C. to 400° C.; 150° C. to 350° C. preferably. In one embodiment, the material is deposited at a rate of 0.5 to 10 \acute{Å}/sec. In one embodiment, the material is deposited at a rate of 0.5 to 1 \acute{Å}/sec. In one embodiment, the material is deposited at a rate of 1 to 2 \acute{Å}/sec. In one embodiment, the material is deposited at a rate of 2 to 3 \acute{Å}/sec. In one embodiment, the material is deposited at a rate of 3 to 4 \acute{Å}/sec. In one embodiment, the material is deposited at a rate of 4 to 5 \acute{Å}/sec. In one embodiment, the material is deposited at a rate of 5 to 6 \acute{Å}/sec. In one embodiment, the material is deposited at a rate of 6 to 7 \acute{Å}/sec. In one embodiment, the material is deposited at a rate of 7 to 8 \acute{Å}/sec. In one embodiment, the material is deposited at a rate of 8 to 9 \acute{Å}/sec. In one embodiment, the material is deposited at a rate of 9 to 10 \acute{Å}/sec. In one embodiment, the final layer thickness is between 10 and 10000 nm. In one embodiment, the final layer thickness is between 10 and 1000 nm. In one embodiment, the final layer thickness is between 10 and 50 nm. In one embodiment, the final layer thickness is between 50 and 100 nm. In one embodiment, the final layer thickness is between 100 and 200 nm. In one embodiment, the final layer thickness is between 200 and 300 nm. In one embodiment, the final layer thickness is between 300 and 400 nm. In one embodiment, the final layer thickness is between 400 and 500 nm. In one embodiment, the final layer thickness is between 500 and 600 nm. In one embodiment, the final layer thickness is between 600 and 700 nm. In one embodiment, the final layer thickness is between 700 and 800 nm. In one embodiment, the final layer thickness is between 800 and 900 nm. In one embodiment, the final layer thickness is between 900 and 1000 nm. In one embodiment, the final layer thickness is between 1000 and 2000 nm. In one embodiment, the final layer thickness is between 2000 and 3000 nm. In one embodiment, the final layer thickness is between 3000 and 4000 nm. In one embodiment, the final layer thickness is between 4000 and 5000 nm. In one embodiment, the final layer thickness is between 5000 and 6000 nm. In one embodiment, the final layer thickness is between 6000 and 7000 nm. In one embodiment, the final layer thickness is between 7000 and 8000 nm. In one embodiment, the final layer thickness is between 8000 and 9000 nm. In one embodiment, the final layer thickness is between 9000 and 10000 nm.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. The use of numerical values in the various ranges specified herein is stated as approximations as though the minimum and maximum values within the stated ranges were both being preceded by the word “about.” In this manner, slight variations above and below the stated ranges can be used to achieve substantially the same results as values within the ranges. Also, the disclosure of these ranges is intended as a continuous range including every value between the minimum and maximum average values including fractional values that can result when some of components of one value are mixed with those of different value. Moreover, when broader and narrower ranges are disclosed, it is within the contemplation of this invention to match a minimum value from one range with a maximum value from another range and vice versa.

What is claimed is:

1. An organic electronic device comprising an anode and a cathode and having organic layers therebetween, wherein the organic layers are, in order:
a buffer layer comprising a conductive polymer and a fluorinated acid polymer;
a hole transport layer;
a photoactive layer comprising a dopant material and a host material; and
an electron transport layer
wherein at least one of the dopant material and the host material is a fused polycyclic aromatic compound.

2. The device of claim 1, wherein both the dopant material and the host material are fused polycyclic aromatic compounds.

3. The device of claim 1, wherein the dopant material has a core structure selected from the group consisting of pentalene, indene, naphthalene, azulene, heptalene, biphenylene, as-indacene, s-indacene, acehaphthylene, fluorene, phenalene, phenanthrene, anthracene, fluoroanthene, acephenanthrylene, aceanthrylene, triphenylene, pyrene, chrysene, tetracene, pleiadene, picene, perylene, pentaphene, pentacene, tetraphenylene, hexaphene, hexacene, rubicene, coronene, trinaphthylene, heptaphene, heptacene, pyranthrene, ovalene, truxene, dibenzosuberan, and combinations thereof.

4. The device of claim 3 wherein the core structure has at least one substituent selected from alkyl, alkenyl, alkynyl, alkoxy, oxyalkyl, oxyalkenyl, oxyalkynyl, fluorinated alkyl, fluorinated alkenyl, fluorinated oxyalkyl, fluorinated oxyalkenyl, fluorinated oxyalkynyl, aryl, heteroalkyl, heteroalkenyl, heteroalkynyl, heteroaryl, —CN, —OR, —CO₂R, —SR, —N(R)₂, —P(R)₂, —SOR, —SO₂R, —NO₂, —R³—OH, —CH₂—C₆H₅, —R³—C(O)O-Z, —R³—O—R⁵, —R³—O—R⁴—C(O)O-Z,
—R³—O—R⁴—SO₃Z, and —R³—O—C(O)—N(R⁶)₂; where all “R” groups are the same or different at each occurrence and:
R is selected from alkyl and aryl
R³ is a single bond or an alkylene group
R⁴ is an alkylene group
R⁵ is an alkyl group
R⁶ is hydrogen or an alkyl group
Z is H, Li, Na, K, N(R⁵)₄ or R⁵.

5. The device of claim 3, wherein the core structure has at least one diarylamino substituent.

6. The device of claim 5, wherein the core structure has at least one additional substituent selected from the group consisting of amino, alkyl, fluoro, fluoroalkyl, alkoxy, fluoroalkoxy, aryloxy, fluoroaryloxy, fluoroalkylaryloxy, aryl, fluoroaryl, and fluoroalkylaryl.

7. The device of claim 1, wherein the dopant has a core structure selected from the group consisting of anthracene, chrysene, pyrene, tetrahydropyrene, hexahydropyrene, rubrene, periflanthene, imidodibenzyl, xanthene, coumarin, and boron, [(1,2-dihydro-2,2′-methylidynediquinolinato)(1-)]difluoro derivatives.

8. The device of claim 7 wherein the core structure has at least one substituent selected from alkyl, alkenyl, alkynyl, alkoxy, oxyalkyl, oxyalkenyl, oxyalkynyl, fluorinated alkyl, fluorinated alkenyl, fluorinated oxyalkyl, fluorinated oxyalkenyl, fluorinated oxyalkynyl, aryl, heteroalkyl, heteroalkenyl, heteroalkynyl, heteroaryl, —CN, —OR, —CO₂R, —SR, —N(R)₂, —P(R)₂, —SOR, —SO₂R, —NO₂, —R³—OH, —CH₂—C₆H₅, —R³—C(O)O-Z, —R³—O—R⁵, —R³—O—R⁴—C(O)O-Z,
—R³—O—R⁴—SO₃Z, and —R³—O—C(O)—N(R⁶)₂; where all “R” groups are the same or different at each occurrence and:
R is selected from alkyl and aryl
R³ is a single bond or an alkylene group
R⁴ is an alkylene group
R⁵ is an alkyl group
R⁶ is hydrogen or an alkyl group
Z is H, Li, Na, K, N(R⁵)₄ or R⁵.

9. The device of claim 3, wherein the dopant material comprises at least two core structures joined together.

10. The device of claims 1 or 9 wherein the dopant material comprises a heterocyclic ring.

11. The device of claim 1, wherein the host material has a core structure selected from the group consisting of pentalene, indene, naphthalene, azulene, heptalene, biphenylene, as-indacene, s-indacene, acehaphthylene, fluorene, phenalene, phenanthrene, anthracene, fluoroanthene, acephenanthrylene, aceanthrylene, triphenylene, pyrene, chrysene, tetracene, pleiadene, picene, perylene, pentaphene, pentacene, tetraphenylene, hexaphene, hexacene, rubicene, coronene, trinaphthylene, heptaphene, heptacene, pyranthrene, ovalene, truxene, dibenzosuberan, and combinations thereof.

12. The device of claim 11, wherein the core structure has at least one substituent selected from the group consisting of alkyl, fluoro, fluoroalkyl, alkoxy, fluoroalkoxy, aryloxy, fluoroaryloxy, fluoroalkylaryloxy, aryl, fluoroaryl, and fluoroalkylaryl.

13. The device of claim 11, wherein the core structure has at least one substituent selected from alkyl, alkenyl, alkynyl, alkoxy, oxyalkyl, oxyalkenyl, oxyalkynyl, fluorinated alkyl, fluorinated alkenyl, fluorinated oxyalkyl, fluorinated oxyalkenyl, fluorinated oxyalkynyl, aryl, heteroalkyl, heteroalkenyl, heteroalkynyl, heteroaryl, —CN, —OR, —CO₂R, —SR, —N(R)₂, —P(R)₂, —SOR, —SO₂R, —NO₂, —R³—OH, —CH₂—C₆H₅, —R³—C(O)O-Z, —R³—O—R⁵, —R³—O—R⁴—C(O)O-Z,
—R³—O—R⁴—SO₃Z, and —R³—O—C(O)—N(R⁶)₂; where all “R” groups are the same or different at each occurrence and:
R is selected from alkyl and aryl
R³ is a single bond or an alkylene group
R⁴ is an alkylene group
R⁵ is an alkyl group
R⁶ is hydrogen or an alkyl group
Z is H, Li, Na, K, N(R⁵)₄ or R⁵.

14. The device of claim 11 wherein the host material comprises at least two core structures joined together.

15. The device of claims 1 or 14 wherein the host material comprises a heterocyclic ring.

16. The device of claim 1, wherein the host has a core structure selected from the group consisting of fluorene, naphthalene, pyrene, perylene, chrysene, tetrahydropyrene, and hexahydropyrene.

17. The device of claim 1 wherein at least one of the buffer layer, the hole transport layer, and the photoactive layer is deposited from a liquid medium.
